(19) United States
(12) Patent Application Publication
(10) Pub. No.: US 2002/0065721 A1
(43) Pub. Date: May 30, 2002

(54) System and method for recommending a wireless product to a user

(76) Inventors: Christian Lema, Antioch, CA (US); Ralph L. Keeney, San Francisco, CA (US); Matthew H. Fuller, San Francisco, CA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/970,801

(22) Filed: Oct. 5, 2001

Related U.S. Application Data
(63) Continuation of application No. 09/769,315, filed on Jan. 26, 2001.
(60) Provisional application No. 60/178,464, filed on Jan. 27, 2000.

(51) Int. Cl. G06F 17/60

(52) U.S. Cl. 705/14

(57) ABSTRACT

An intelligent system recommends a wireless product using a value-based framework. A product recommendation engine creates and delivers a survey requesting information from a user regarding wireless products needs and objectives. The user's response is captured and stored. The user's response is processed by an evaluation engine in conjunction with a logic engine for applying rules to reach a set of wireless products alternatives. The evaluation engine then enables the user to compare product attributes to narrow the list of alternatives. The product recommendation engine learns from itself, continually adding new inferences into its rule base. As new products are introduced, the product recommendation engine reviews previous recommendations to alert the user if the newly-introduced product better meets the user's needs. When a product is recommended to a user, an explanation engine explains the product recommendation based on the product's attributes and the user's objectives.

### I. RELATED APPLICATIONS

This application claims the benefit of U.S. Provisional Patent Application No. 60/178,464 filed Jan. 27, 2000, which is incorporated herein by reference.

### II. BACKGROUND OF THE INVENTION

A. Field of the Invention

The present invention relates to systems and methods for recommending a wireless product to a user. More particularly, the present invention relates to systems and methods for using a value-based framework to recommend a wireless product to a user.

B. Description of the Related Art

Wireless businesses today employ a variety of techniques to assist customers in selecting a product (i.e., a wireless product or wireless service) from among several options. In conventional retail settings, a salesperson is often available to talk with a customer and determine what product or service meets the customer's needs. Similarly, online retailers, such as retailers on the World Wide Web, may use a product advisor or product recommendation engine to interact with a customer and determine the product or products best matched to the customer's needs. For example, a product recommendation engine used by a software Website might ask an online customer what type of operating system his computer uses. The product recommendation engine would then recommend only products that are compatible with the specified operating system.

As shown in this example, a product, such as a software product, has a set of attributes, such as operating system compatibility, cost, etc. A conventional product recommendation engine relies on matching and filtering these product attributes. Customers are asked questions designed to eliminate one or more products based on attributes of the product or a category of the product. The questions and answers are used as filters to reach a product recommendation via a process of elimination.

However, the product recommended by conventional product recommendation engines frequently is not the best product for the customer. This problem occurs for two reasons: first, there is an assumption that the customer understands how the different attributes affect the product's usage and value to the customer; and second, a product that is filtered out because of a customer's answer may never be offered to the customer even if it supercedes all others as the best choice based on its other attributes. Because the conventional interaction focuses on product attributes rather than the customer's needs and objectives, the product recommendations are frequently not the best for the customer.

For example, a customer in an electronics store might look to a salesperson to find a product for managing a hectic schedule. The salesperson would likely ask several questions, such as:

1. Do you like Palm or Windows CE?

2. Do you use Outlook?

3. How much RAM will you need?

4. What are you looking to spend?

5. What kind of computer do you have at home?

Based on these questions, the salesperson is trying to discover the following:

1. Which Operating System is necessary?

2. Must the product integrate with existing software (e.g., Outlook)?

3. Which product can be recommended based on the RAM required?

4. Which product can be recommended based on price?

5. Which product meets the cabling and conduit needs?

The answers to the first two questions will enable the salesperson to pick from handheld and palmtop computers. The other answers will then determine which computer is appropriate based on price, RAM and conduits.

This process is flawed in many ways. For example, the salesperson never determines whether a computer is necessary in the first place. Perhaps the customer really needs a voice recorder/note taker, a simple electronic organizer that does not interact with a computer, or a day planner from the stationary store next door. Another problem is that the questions would be difficult for any customer who isn't technically savvy. The questions focus on information that the customer may not care about, and the customer likely does not understand the implications of his answers. Overall, the conventional approach is not easy or friendly because it reaches a recommendation based on attributes of the products in the available product set, not the user's objectives.

The product recommendation process at conventional online retailers is not much improved. For example, if a customer attempting to purchase a cellular phone online is not sure which cellular phone he wants, the customer can consult an online advisor to help select the appropriate phone or calling plan. The online advisor will likely ask questions such as:

1. How much do you want to spend per month?

2. What wireless technology do you want your calling plan to support (e.g., digital PCS, digital cellular, etc.)?

3. How many minutes do you expect to use your cellular phone per month?

4. Which features are you interested in (voicemail, caller ID, etc.)?

With these types of questions, the customer is expected to know how many minutes they plan to talk on the phone and which technology their plan must support. These metrics are rarely known or understood by the typical customer. Even someone well-versed in the industry may have a hard time distinguishing between digital PCS and digital cellular service. With a conventional online advisor, how the customer answers the questions, even in which order, determines the product recommended. Once the customer answers the first two questions, many possible products are immediately eliminated. All digital PCS products will disappear if the customer selects digital cellular, even though the customer may not understand this attribute value. Similarly, using price filters, the online advisor might eliminate a product that costs ten dollars more per month but is overall a better solution for the customer.

As the examples above show, conventional product recommendation systems, including online product advisors, have many flaws. Five drawbacks with conventional online product advisors can be summarized as follows:

1. Individuals are asked to rate how important objectives are. Asking a customer to rank the importance of an objective is ambiguous and does not result in a better decision. For instance, a customer buying a car might decide that cost is not too important, rating it a 2 (on a 1-5 scale of importance where 5 is most important) while rating reliability a 4. This suggests that reliability is twice as important as cost to this customer. However, this rating does not suggest how much more the customer would pay to increase reliability. Does it mean the customer would be willing to double the price of the car to improve the reliability by 50 percent? That seems very unlikely. Given this rating system, one cannot conclude anything about how much the additional reliability is worth in terms of increased costs.

2. Most product recommendation systems do not elicit customer values. Most product recommendation engines allow a customer to choose among products using screening criteria as described above to help customers focus on product attributes. If the product recommendation system instead focused on the customer's needs and objectives, it would be better able to help the customer select the best product.

3. Most product recommendation systems do not retain information about customer values. The few product recommendation engines that do gather information about a customer's values do not preserve that information, partly because the information does not have much future value. Instead, conventional systems might keep a record of the customer's purchases and the related product attributes. Without information about a customer's values, these systems can only recommend future products and services based on the attributes of products purchased in the past.

4. The basis for recommending a product is not given. Conventional product recommendation engines recommend a product that matches the product attributes given by the customer. This explanation can be presented to the customer, but a list of product attributes does not explain to the customer why the recommended product meets the customer's objectives.

5. Complex product recommendations require human intervention. Typical product recommendation engines cannot automatically recommend a complex product (e.g., a home mortgage) or one that has product dependencies (e.g., a wireless phone and a service plan). Instead, these systems either present several options and force the customer to determine a recommendation or gather data from the customer and follow up with human interaction, e.g., a telephone call, to make a recommendation.

Some conventional systems use Java chat applets that enable “live” discussions with human agents online, without resorting to telephone calls. However, all of these systems lose the advantages of self-service product recommendation assistance. For example, the retailer must incur significant expense training its staff. Also, the service provided can be inconsistent based on different levels of expertise among the staff.

These and other problems with conventional product recommendation engines result in customers who are more likely to be frustrated by the process and end up selecting inferior products. In the wireless industry, this can lead to unmet expectations that result in both brand dilution and churn (i.e., the process whereby customers switch from one carrier to another, with the goal of getting better services or products). Intelligent systems developed recently attempt to solve these problems using simple statistics or group purchasing patterns (e.g., “many people who purchased this item also liked . . . ”). These systems fall victim to the same problems discussed above, failing to obtain or consider a specific customer's needs and objectives. The present invention is directed to solving one or more of the drawbacks inherent in the prior art.

### III. SUMMARY OF THE INVENTION

The present invention provides an intelligent system for recommending a wireless product (i.e., a wireless product, service, policy, or feature of any type) using a value-based framework, resulting in the recommendation of alternatives that might not be considered in conventional attribute-filtering product recommendation advisors. By translating the needs and objectives of a user into product attributes, a system consistent with the present invention functions as an intelligent advisor but does not require the user to know or understand technical information about wireless products.

In one embodiment of the present invention, a wireless product is recommended to a user by interacting with the user to obtain the user's objectives for the wireless product. A set of rules is used to map the user's objectives to a corresponding set of product attributes and one or more wireless product alternatives are selected having at least one of the product attributes. The user is enabled to evaluate the one or more wireless product alternatives by comparing the product attributes of the one or more wireless product alternatives and a recommended wireless product is presented to the user.

In another embodiment of the present inventions, a system for recommending a wireless product to a user includes a survey engine configured to obtain information from a user relating to the user's objectives for the wireless product and a logic engine having a rule set configured to apply one or more rules in the rule set. The system also includes an evaluation engine configured to process the user's response to determine product attributes corresponding to the user's objectives, select one or more wireless products based on the product attributes corresponding to the user's objectives, interact with the user to evaluate the one or more wireless products by comparing the product attributes of each of the one or more wireless products, and determine a wireless product recommendation from among the one or more wireless products. The system further may include an explanation engine configured to explain the product recommendation based on the product attributes and the user's objectives.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### IV. BRIEF DESCRIPTION OF THE DRAWINGS

FIG. 1 is a block diagram of a product recommendation engine 100 consistent with the present invention.

FIG. 2 is a flow chart of the steps performed by product recommendation engine 100 in one embodiment of the present invention.

FIG. 3 is a flow chart of the steps performed by survey engine 110 in one embodiment of the present invention.

FIG. 4 is a flow chart of the steps performed by logic engine 108 in one embodiment of the present invention.

FIG. 5 is a flow chart of the steps performed by evaluation engine 112 in one embodiment of the present invention.

FIG. 6 is a flow chart of the steps performed by evaluation engine 112 in another embodiment of the present invention

FIG. 7 is a sample screen shot depicting one way evaluation engine 112 can present product alternatives to a user.

FIG. 8 is a sample screen shot depicting one way evaluation engine 112 can use a Java applet to enable a user to rank and rate each attribute value based on a percentage.

FIG. 9 is a sample screen shot depicting one way evaluation engine 112 can add columns to a comparison table to enable a user to rank and rate each attribute value based on a exclusionary filters.

FIG. 10 is a sample screen shot depicting a comparison table with columns added for ranking and rating product alternatives.

FIG. 11 is a flow chart of the steps performed by explanation engine 106 in one embodiment of the present invention.

FIG. 12 is a sample screen shot depicting how the product recommendation and justification might appear to the user.

### V. DETAILED DESCRIPTION OF THE INVENTION

A. Introduction

Consistent with the present invention, a product recommendation engine interviews a user to obtain value-based information, evaluates wireless product alternatives, recommends the product that best meets the user's values, and verifies the configuration of any available options based on product dependencies. The product recommendation engine can also assist a company in developing a policy or template for selecting wireless products. Additionally, it can issue an alert to the user when a newly-introduced product is a better match for the user's values.

Users of the product recommendation engine can range from consumers to consultants to sales staff interfacing with the product recommendation engine using a computing device. The product recommendation engine can be deployed on a single machine or on a network, enabling its use on items as small as a handheld computing device, and as large as the Internet.

B. Definitions

The following definitions are provided to facilitate understanding.

Remote Computing Device—any machine (e.g., computer, handheld device, etc) that connects to a network of computers in order to access centralized or distributed services and/or information, such as personal computers attached to the Internet.

Value-Based Framework—A decision framework designed to leverage a user's fundamental objectives and helps connect product attributes to the user's values.

Data Store—Any computing storage mechanism for data, such as a database or text file.

IDE—Integrated Development Environment.

Inference Rule—A rule stating what can validly be concluded from existing facts.

Backward Chaining—A problem solving method that starts with a goal or hypothesis and works backwards using rules to find what facts are necessary to prove the goal or hypothesis.

Forward Chaining—A problem solving method that applies rules starting with data and draws conclusions from that data.

Conditional Clause—In a rule in an expert system, a condition whereby some action should be taken whenever the condition is satisfied.

Resultant Clause—In a rule in an expert system, an action triggered when a conditional clause is satisfied.

Rule Base—An expert system using, for example, “if-then” rules to represent knowledge.

Knowledge Base—A collection of facts and rules capturing specialized knowledge in an expert system.

Smart Screening—A decision process for eliminating alternatives by using, for example, a consequence table. The process can allow a user to view any alternatives removed, for example, by changing attribute filters.

Trade-Off Decision—A decision where multiple alternatives have conflicting objectives. A user can reduce or eliminate one objective to achieve more in terms of a conflicting objective.

Ranking—A listing of one or more alternatives, for example in priority order.

Rating—A listing of one or more alternatives, for example in order of an alternative's weight as a portion of total points. For instance, a first alternative with 50 points is twice as desirable as a second alternative with 25 points.

C. Understanding the Value-Based Framework

As described above, systems consistent with the present invention use a value-based framework to help a user find the wireless product that best matches the user's needs and objectives. A user shopping for a wireless phone might state his needs and objectives as follows:

1. “I need the cheapest cell phone available to me now! I don't need it to last forever.”

2. “I need to get a cell phone for work. I am the last person on the team without one.”

3. “I need to decide which phone and plan my company should use.”

A product recommendation engine consistent with the present invention can process each of these statements to determine which wireless product to recommend.

In the first statement, the user reveals a preference for speed (“available to me now”) and low cost (“cheapest cell phone”). These objectives can be stored in a profile for this user as follows:

Price (X, cheap)

Availability (X, immediate)

Commitment (X, not long)

This information can be translated into objectives such as “minimize cost” and “maximize availability.” The user would then be shown a list of objectives with “minimize cost” and “maximize availability” already checked. The system wouldn't automatically check any objective regarding commitment because commitment is represented as a negative (“not long”) which doesn't necessarily correlate to the opposite being true (i.e. “not long” commitment does not equal a value for “short” commitment). The user can then check any further objectives, which will be used to help reach the best product recommendation.

The second statement illustrates more complex user objectives (“cell phone for work” and “last person on the team without one”). Immediately, the system can observe the following data:

Intended_Use (X, Business)

Based on this data, to successfully recommend a set of product alternatives, the product recommendation engine must have answers to some more questions. Does the company have a set policy when it comes to cellular phone purchases? Will the user need the phone for just business or for personal use as well? Are there specific discounts if the user buys a phone that the rest of the company already has?

Instead of asking the user for more information, the product recommendation engine can search its data stores and present the data found to the user for verification. The product recommendation engine could look up the following:

LoginName (X, login)

User (ID, X)

Company (Y, ID)

CorpPolicy (X, Y)

This information enables the product recommendation engine to infer either: 1. which phones to present, if the company has a cell phone policy; or 2. which phones are most commonly purchased by employees of the company, if the company does not have a cell phone policy. The product recommendation engine can get data by calculating it, inferring it, or asking the user.

The third statement illustrates the user's objective of devising a company policy (“which phone and plan my company should use”). In the first two statements, data was captured that helped the product recommendation engine know which rules to run. In this statement, however, the user creates rules that are run each time an employee seeks the appropriate wireless product. These rules enable each company to create a set of filters to match the company's buying philosophy or corporate culture. These filters then provide a starting point for product recommendations for the company's employees.

The rules below depict a wireless phone policy for a company with two offices and two types of users with a significant commitment to lower overall cost and high coverage quality.

Activ_Market (2, Company) if company=x then activ_markets=2

Office (NY, Company) if company=x then location=NY

Office (SF, Company) if company=x then location=SF

Usertype (tech, Company) if company=x then usertype=tech

Usertype (sales, Company) if company=x then usertype=sales

TotalCost (Lowest, Company) if company=x then totalcost=lowest

CovQuality (High, Company) if company=x then covquality=high

D. Detailed Description of One Embodiment

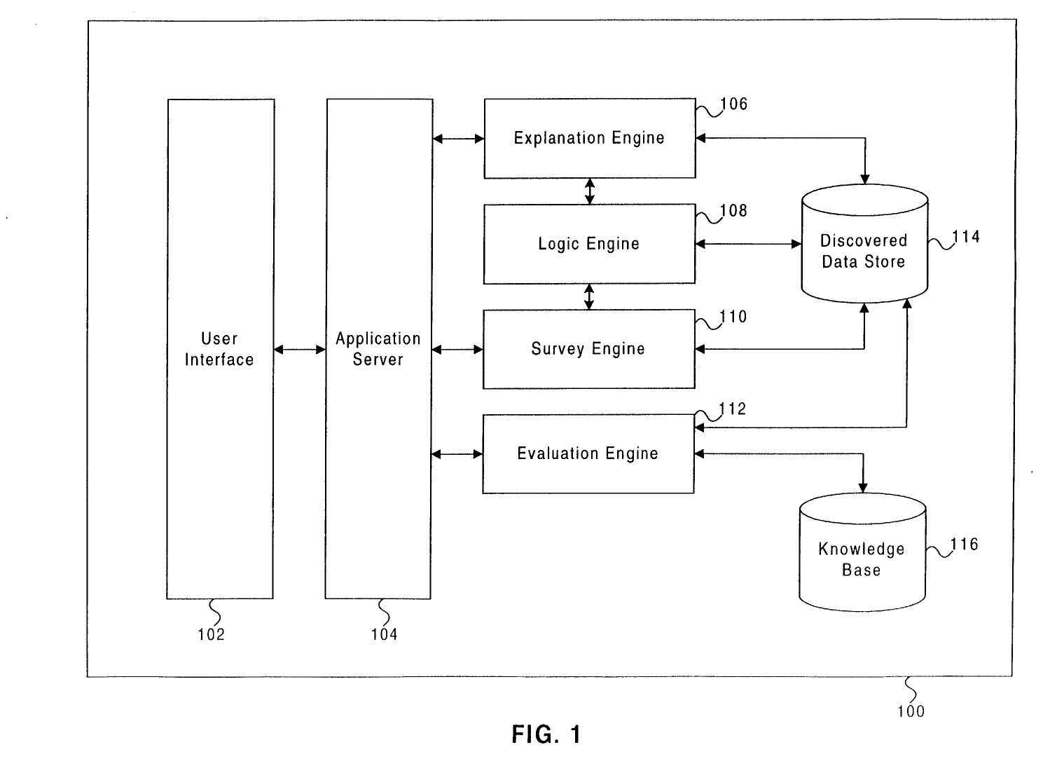

FIG. 1 is a block diagram of a product recommendation engine 100 consistent with the present invention. Product recommendation engine 100 comprises a user interface 102, an application server 104, an explanation engine 106, a logic engine 108, a survey engine 110, an evaluation engine 112, a discovered data store 114, and a knowledge base 116.

User interface 102 is a graphical user interface (GUI) created dynamically by application server 104. Application server 104 can be any available Web application server (e.g., Sapphire\Web, Cold Fusion, ASP, etc.) using a data-aware scripting language (e.g., Perl, VBscript, Javascript, etc.). Typically, user interface 102 is presented to a user at a client computer running a browser (e.g., Microsoft Internet Explorer, Netscape Navigator, etc.), not shown. Application server 104 builds the screens for user interface 102 by interfacing with objects running in the memory of any of the engines depicted in FIG. 1 (i.e., explanation engine 106, logic engine 108, survey engine 110, and evaluation engine 112). For example, a customer object working in logic engine 108 might need more data, e.g., a property set, from the user. Logic engine 108 would pass a request to application server 104, and application server 104 would configure an existing template to present a GUI requesting the information from the user. Code for this example could be as follows:

Code Listing 1 (Cold Fusion Example)

<html>
<body>
<CFObject action=“CREATE” name=“objCustomers”
class=“RecsCOM.Ccustomers” context=“INPROC”>
<CFLOOP COLLECTION #objCustomerData#ITEM=objCustomer>

<CFOUTPUT>

<FORM ... >

#objCustomer.SSNumber-Question#
<input type=“text” name=“#objCustomer.Label# size=

50>

</FORM>

</CFOUTPUT>

</CFLOOP>
<CFSET objCustomer.SSNumber>
</body>
</html>

As shown in FIG. 1, in one embodiment, explanation engine 106, survey engine 110, and evaluation engine 112 interact with the user by directing application server 104 to create the GUI code for user interface 102 to read.

In an embodiment that is not Web-based, perhaps a handheld application, user interface 102 and application server 104 could be implemented using, for example, the Palm Software Development Kit, Satellite Forms from Puma, or an IDE.

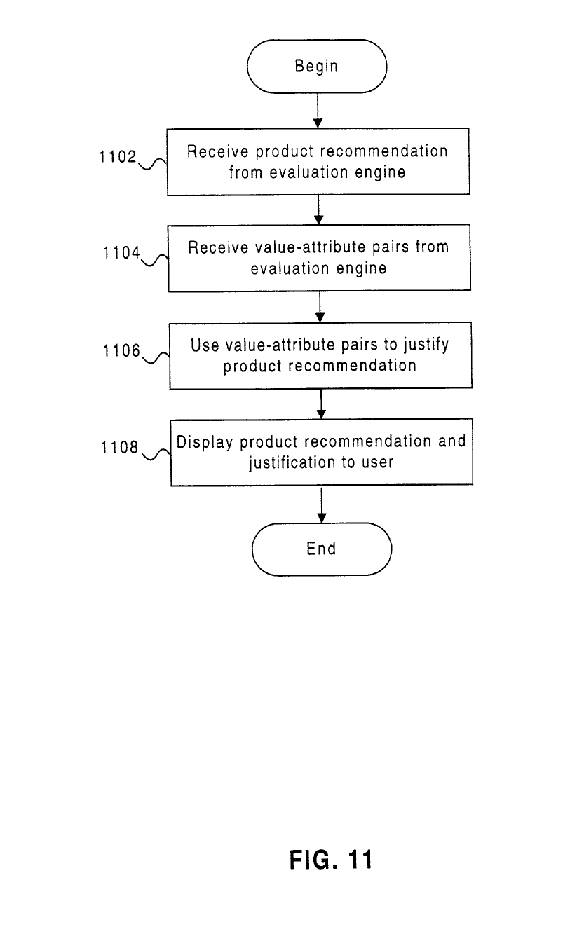

Explanation engine 106 uses rules to justify any conclusions the product recommendation engine reaches and creates an explanation for the user, as described in detail below with reference to FIG. 11.

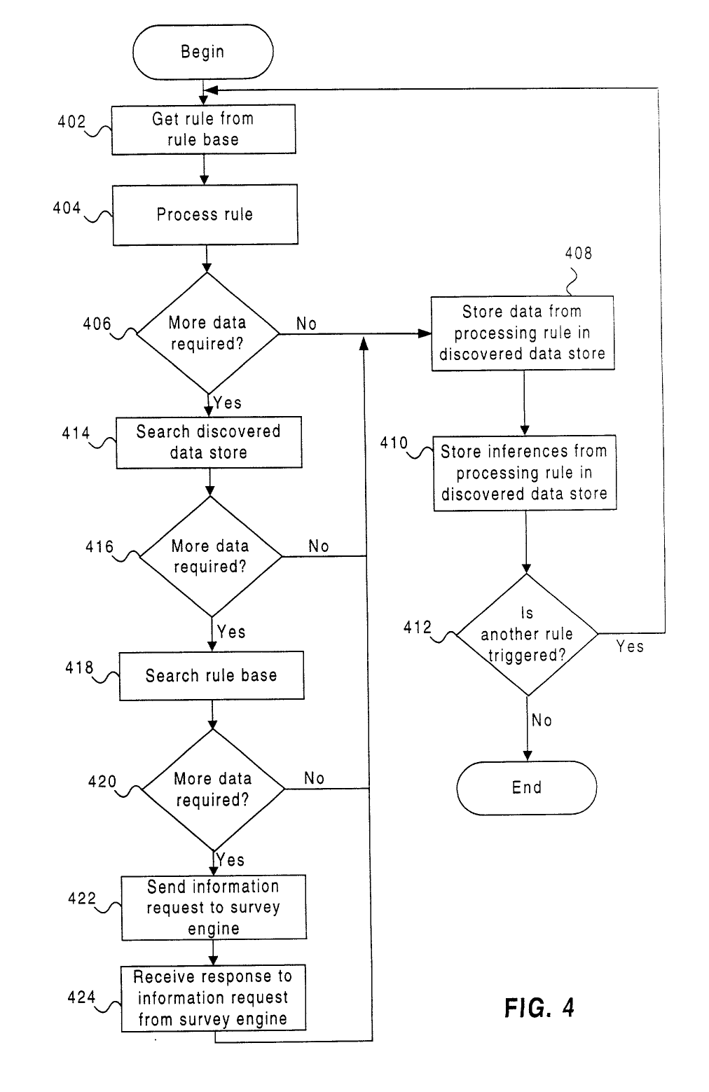

Logic engine 108 interprets data stored in discovered data store 114 and solves for either the truth of a statement or a particular variable. Logic engine 108 stores rules, for example, in a rule base. Logic engine 108 is described in detail below with reference to FIG. 4.

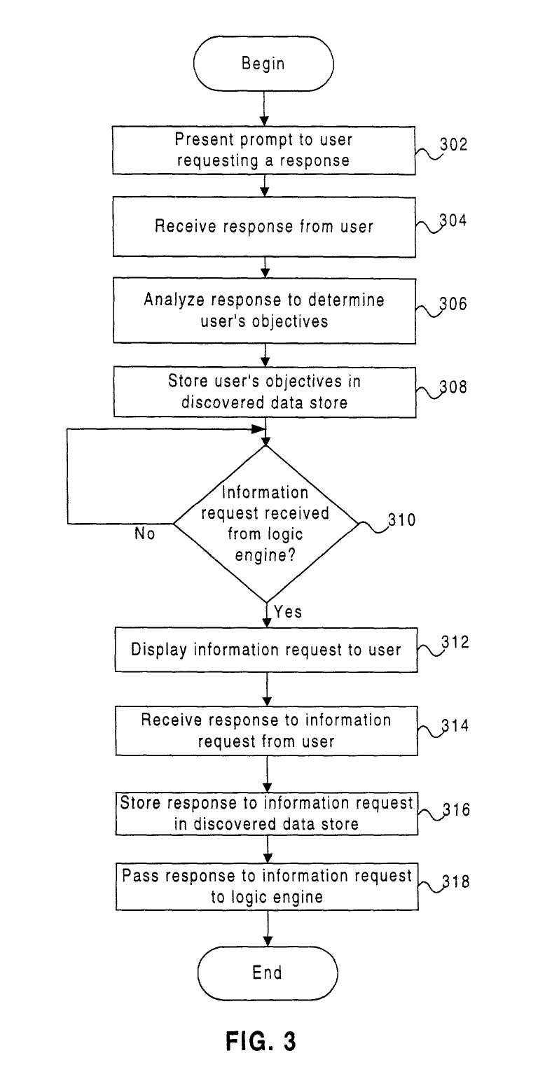

Survey engine 112 generates a survey and captures information from the user, as described in detail below with reference to FIG. 3.

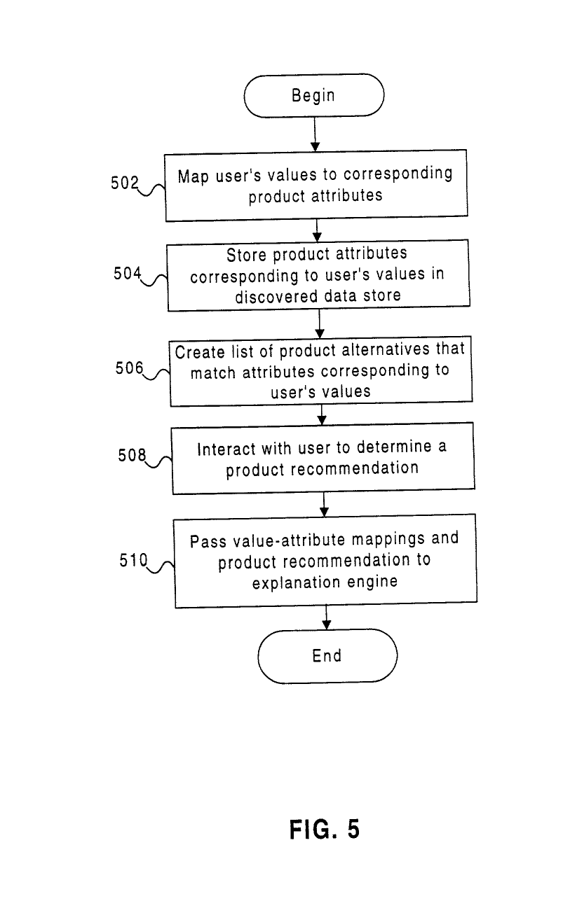

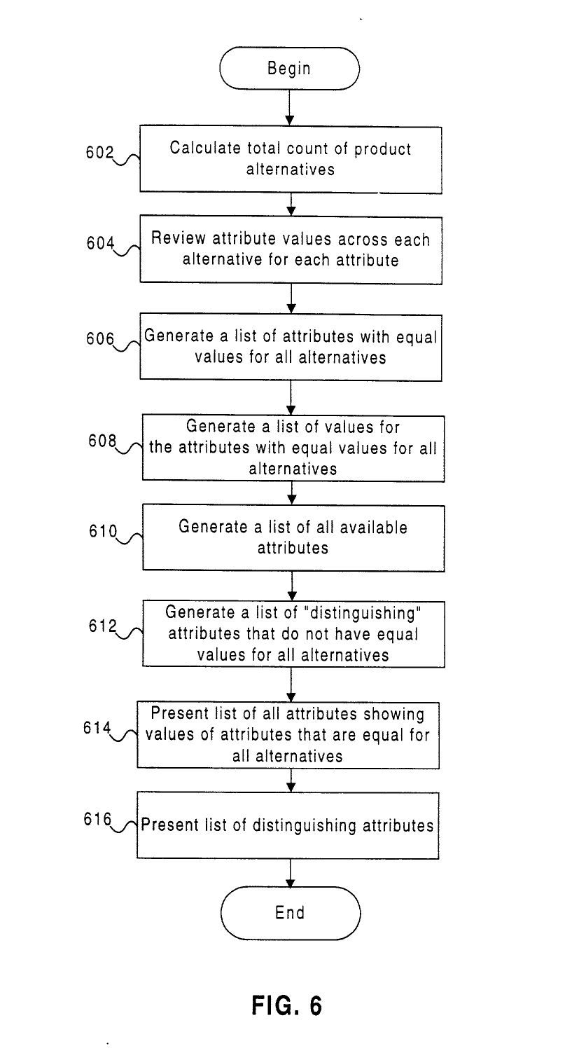

Evaluation engine 112 matches a user's objectives to product attributes to determine a set of product alternatives matching the user's objectives. Once the set of product alternatives is presented to the user, evaluation engine 112 enables the user to compare attributes of the product alternatives, as described in detail below with reference to FIGS. 5 and 6.

Discovered data store 114 stores data received from the user, inferences made by the logic engine, and policy templates for companies. Data from the user can include survey responses or answers to subsequent information requests. Inferences are generally made by the logic engine as it interacts with knowledge base 116. Discovered data store 114 also stores user data (e.g., address, credit card data, previous purchases) for use in making future recommendations to the user.

Knowledge base 116 stores a catalog of available wireless products, including product attributes and categories. Knowledge base 116 can function as a “learning” database that accumulates data on an incremental basis as each survey is proctored. Logic engine 108 can use this accumulated data to make inferences, leading to faster recommendations as knowledge base 116 gets larger.

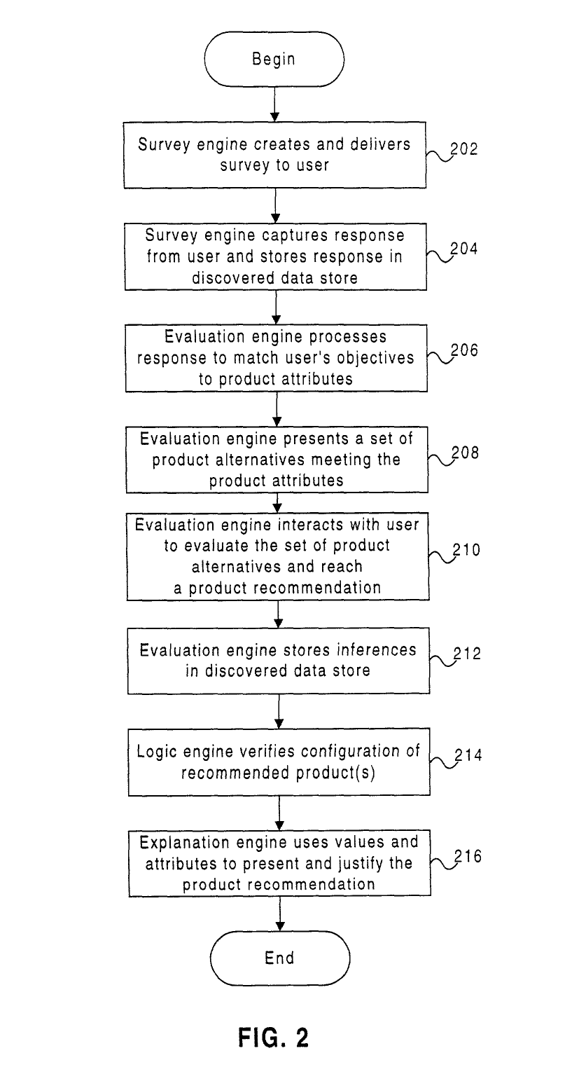

FIG. 2 is a flow chart of the steps performed in one embodiment of the present invention. Survey engine 110 creates and delivers a survey to a user (step 202) and then captures a response from the user and stores the response in discovered data store 114 (step 204). Evaluation engine 112 processes the response to match the user's objectives to product attributes (step 206). Evaluation engine 112 presents a set of product alternatives meeting the product attributes corresponding to the user's objectives (step 208).

Evaluation engine 112 interacts with the user through a series of decision screens to evaluate the set of product alternatives and reach a wireless product recommendation (step 210). Evaluation engine 112 stores any inferences made in discovered data store 114 (step 212). Logic engine 108 verifies the configuration of the wireless product recommendation (step 214) and explanation engine 106 uses objectives and attributes from evaluation engine 112 to justify the wireless product recommendation (step 216).

FIG. 3 is a flow chart of the steps performed by survey engine 110. Survey engine 110 presents a prompt to the user requesting a response (step 302). In one embodiment, the screen presented enables the user to communicate his objectives in natural language. For example, the prompt might look as follows:

In order to best understand your objectives in buying and using a wireless product, please explain in the text box below (in no more than 200 words) what characteristics will influence how satisfied you will be with your wireless product.

Survey engine 110 receives a response from the user (step 304) and analyzes the response to determine the user's objectives (step 306). The analysis can be done using well-known text parsing and keyword searching. Alternatively, syntactical analysis could be performed and a parse tree could be used to interpret the given text. Survey engine 110 stores the user's objectives in discovered data store 114 for use by other system components (step 308).

In addition to the initial information gathering described above, survey engine 110 is used by logic engine 108 for subsequent information requests. When an information request is received from logic engine 108 (step 310), survey engine 110 displays the information request to the user (step 312) and receives the user's response to the information request (step 314). Survey engine 110 stores the response in discovered data store 114 (step 316) and passes the response to logic engine 108 (step 318). For its interactions with the user, survey engine 110 uses application server 104 and user interface 102, as described above.

FIG. 4 is a flow chart of the steps performed by logic engine 108. In one embodiment, logic engine 108 includes a rule base, a well-known data structure. When logic engine 108 gets a rule from the rule base (step 402), it processes the rule, for example, to solve for a variable or determine the truth of a statement (step 404). The processing may require additional data (step 406). If so, logic engine 108 searches discovered data base 114 for the needed data (step 414). If more data is still needed (step 416), logic engine 108 searches its rule base for a rule containing the needed data (step 418). If the needed data is not found (step 420), logic engine 108 can send an information request to survey engine 110 (step 422) and receive a response to the information request from survey engine 110 (step 424).

Once logic engine 108 has enough data to process the rule, logic engine 108 stores the result in discovered data store 114 (step 408). Logic engine 108 also stores any inferences made during the rule processing in discovered data store 114 (step 410). If another rule is triggered (step 412), then the process is repeated. As depicted in FIG. 1 and explained above, logic engine 108 interacts with discovered data store 114, enabling it to use discovered data to determine if any other information can be calculated or inferred, minimizing the interactions with the user.

Of the engines depicted in the embodiment shown in FIG. 1, only the logic engine does not directly interface with application server 104. In this embodiment, logic engine 108 interacts with explanation engine 106 or survey engine 110 for its outputs. As described above, logic engine 108 operates as an inference engine that runs on rules found in its rule base. The rule base stores the rules used by product recommendation engine 100 to evaluate wireless products against a user's objectives.

1. Explanation of Rules

The sample rules listed below demonstrate two different kinds of rules stored in the rule base, inference rules and management rules.

Code listing 2A (Inference Rules)

GoldCustomer=customer.anywhere purchase.last>500 AND purchase.average>200

If customer is goldcustomer and service is Sprint, then upgrade_plan_family to wirelessweb

Code Listing 2B (Management Rules)

IF more than one rule IS triggered, ORDER BY rule_priority The syntax for these rules differs to enable different methods for interpreting the rules. These rules illustrate both English language and variable based approaches. The example in code listing 1 above uses logic formalisms to demonstrate similar rule capturing.

In one embodiment of the present invention, inference rules are used to handle conditional processing and make the data inferences necessary to recommend wireless products. The inference rules can be characterized either as conditional rules or definitional rules. Conditional rules have clauses and typically follow the format of “if-then-else” rules. The clauses are used to determine whether a rule needs to be processed, and are then used to alter values or trigger events in product recommendation engine 100. Definitional rules are similar to the logic of object-oriented software development. Objects inherit characteristics from their parent objects. Unless an object has its own value that overrides the value of its parent, product recommendation engine 100 can use definitional rules to “inherit” data. Definitional rules can be rewritten as conditional rules if necessary, as shown in the example below:

Code listing 3

CarrierTechnology (PacificBell, GSM)

PhoneCarrier (Nokia 6190, PacificBell)

If phone is Nokia 6190 then carrier is PacificBell

If carrier is PacificBell then CarrierTechnology is GSM

In this embodiment, management rules help product recommendation engine 100 know how to manage the rules and its components. For example, a rule could be created to instantiate a new logic engine whenever a certain number of users are connected, or whenever a rather long rule set needs to be initiated.

These two rule types (i.e., inference rules and management rules) enable product recommendation engine 100 to manage knowledge and computing resources. When logic engine 108 is instantiated, the rule base is searched and an index is created. This index takes the clauses in each of the rules and creates linked lists, resulting in a network that enables logic engine 108 to search quickly through the complete list of rules to determine which rules to run. A typical rule consists of a conditional clause and a resultant clause. In the example in code listing 3, the first rule has one conditional clause (“If phone is Nokia 6190”) and one resultant clause (“then carrier is PacificBell”). These clauses instruct logic engine 108 what rules to trigger.

2. Backward Chaining Rules

If logic engine 108 is trying to determine if a particular modem is available for the phone the user just purchased, it can use backward chaining rules, where conditions are met moving backwards until every condition is met. Logic engine 108 searches discovered data store 114 to determine whether the information is stored there. If not, logic engine 108 searches the rule base for any rules that have a resultant clause including the modem. It might find one that states that a certain type of modem works for GSM phones. Logic engine 108 must then determine whether the phone is GSM. If no such data exists in discovered data store 114, logic engine 108 searches its rule base for any rules that exist for GSM phones. It may then find one like that listed in code listing 3 above (i.e., If carrier is PacificBell then CarrierTechnology is GSM). In this way, logic engine 108 continues moving backwards by first searching discovered data store 114 and then its rule base. This is a generic backward chaining example. Sometimes, no data is known throughout the whole backward chain. This leads logic engine 108 to calculate the data using other rules or to ask the user for this information via survey engine 110. When a rule is stored in the rule base, it is often linked to a question. This question is passed to survey engine 110 when the data for a variable is unknown.

Within this embodiment of product recommendation engine 100, the rule base contains rules that reference objects. These objects can be held in well-known object databases or the objects can be stored as records in a standard relational database. In either case, the clause typically refers to an attribute of an object and the most common methods called on the object are the “get” and “set” methods. These methods act on the attributes and can trigger other methods if the data is not found. The example above illustrates the case where data is empty each time the method “gets” information from the object. When the method finds no data, it triggers other rules that will locate the data (i.e., because the attribute exists in the resultant clause of another rule). In this case, the method calls the “Request_data” method. The Request_data method then calls the appropriate question, which can be stored in the object itself as an attribute. For example:

Code listing 4 (SetPromptText)

// initialize the phone rule base

public void init initPhoneRuleBase (RuleBase rbase) {

rbase. GoalClauseStack=new Stack (); // goals for this rule set

rbase.variableList=new Hashtable ();

RuleVariable carriertech=new RuleVariable (“carriertech”)

Carriertech.setlabels(“GSM TDMA CDMA”);

Carriertech.setPromptText(“What technology does your phone support?”)

Rbase.variableList.put (carriertech name, carriertech)

The code in code listing 4 sets the variable list for a particular object in product recommendation engine 100 (i.e., carrier technology). In this way, product recommendation engine 100 asks questions of the user only when logic engine 108 is either instructed to ask the question (e.g., by a management rule) or when it cannot infer or find the data itself.

3. Forward Chaining Rules

Another type of rule-solving approach is forward chaining. When product recommendation engine 100 recommends accessories for a selected product, logic engine 108 can follow forward chaining rules to determine the appropriate accessories for the selected product. First, logic engine 108 determines what product, e.g., a wireless phone, that was recommended (e.g., by looking up recommendation.phone data). Next, logic engine 108 finds all rules that have clauses including this list of phones and runs the rules found. Logic engine 108 adds any newly discovered or calculated data to discovered data store 114. When no further rules are triggered, the recommendation.accessories data field should contain a list of accessories known to support the phone that was recommended.

4. How Rules are Created

In one embodiment of the present invention, data is linked and stored in database tables before the corresponding rules are created. The tables below depict examples of how the data might be stored for wireless products, such as wireless phones.

TABLE 1
(Dependency Matrix)

| Product | | | |
|---|---|---|---|
| ID | RelationshipTypeID | RelastionshipTypeLabel | RelProductID |
| 12957 | 2 | Is a | 45905 |
| 93748 | 3 | Works in | 22738 |
| 48946 | 1 | Supports | 58474 |

TABLE 2
(ProductTypeMap)

| ProductID | ProductTypeID | ProductTypeLabel |
|---|---|---|
| 12957 | 23 | Battery |
| 93748 | 3 | Plan |
| 48946 | 1 | Phone |
| 45905 | 87 | Nicad |
| 22738 | 4 | Market |
| 58474 | 23 | Battery |

These tables show how product data about wireless products and services might be stored in a relational database. These records can be used to create rules in a configuration matrix rule base. For example, the first record in table 1 demonstrates a particular kind of relationship, a specialization, where one item is a special type of another item. The corresponding rule would look like:

If ProductID=12957 then Type=Battery and Spec Nicad.

The format of records in table 1 illustrates the role of logic engine 108 as a configuration verification device (FIG. 2, step 214). The last record in table 1 can become a rule that states that a particular phone (ProductID 48946) supports a specific battery (ReIProductID 58474).

FIG. 5 is a flow chart of the steps performed by evaluation engine 112 in one embodiment of the present invention. Evaluation engine 112 maps the user's values (stored in discovered data store 114) to corresponding product attributes (stored in knowledge base 116) (step 502). Evaluation engine 112 then stores the product attributes corresponding to the user's values in discovered data store 114 (step 504). Evaluation engine 112 creates a list of product alternatives that match these product attributes (step 506). Evaluation engine 112 interacts with the user to enable the user to compare the different product alternatives and determine a product recommendation (step 508). Evaluation engine 112 then passes the value-attribute mappings and the product recommendation to explanation engine 106 (step 510).

To map the user's values to product attributes, evaluation engine 112 can direct logic engine 108 to run rules from its rule base. As described above, evaluation engine 112 may generate a list of several plans and then narrow that list through interaction with the user. The following rule set is an example of a backward chaining rule set designed to determine the carrier, plan type, and minute range for a user seeking a wireless phone.

Carrier (sprint, cellone, pacbell, nextel, gte)

Plan_Type (digital, analog, dual)

Minute_Range (low, medium, high, superhigh)

For each given object, many variables may exist in knowledge base 116. For example, the carrier object can have many attributes with corresponding value lists, as follows:

[Carrier Facts]

Carrier.Coverage_Area (small, typical, large)

Carrier.Coverage_Quality (low, fine, excellent)

Carrier.Coverage_RemoteArea (yes, no)

Carrier.Carrier_Technology (cdma, tdma, gsm)

Carrier.Antenna_Count (low, medium, high)

Carrier.Registered_User Count (low, medium, high)

Carrier.Drop_Call_Frequency (low, typical, high)

Carrier.Service_Call_Frequency (low, normal, high)

Carrier.Service_Call_Difficulty (normal, high)

Carrier.Activation_TurnAround (immediate, elapsed)

Carrier.Contract_Requirement (0, 1, 2)

Carrier.Radio_Support (yes, no)

Carrier.Internet_Support (yes, no)

The attributes of each carrier object would be set in most cases. However, different users may have different ideas about what “quality” means. In this case, logic engine 108 may use both its rule base and knowledge base 116 to re-calculate some of the data for a product recommendation.

As previously described, evaluation engine 112 stores attributes corresponding to each user in discovered data store 114. As such, the client object for a user seeking wireless products and services might include the following variables:

[User Findings]

Internal_Communication (normal, high)

Coverage_Need (typical, outlyingareas, all)

Long_Distance_Type (state, national, international)

Long_Distance_Need (no, normal, high)

Roaming_Type (no, local, state, national, international)

Roaming_Need (no, low, normal, high)

A business user who needs coverage in outlying areas may not consider a carrier's coverage “high quality” unless the carrier covers the area where the user's company is located. The user's objectives would be met only if his wireless phone functioned at his workplace, located in an outlying area. In this case, the following rule would exist in the rule base to solve this problem.

If client.coverage_need=outlyingareas and

Carrier.Coverage_RemoteArea=no

then Carrier.coverage_Quality=low

This might be the only rule necessary to remove all but one carrier from the market availability list and therefore it would act as a filter on the set of carriers available. This rule would be triggered when a user specifies that one of his primary objectives is high coverage quality, that the phone will be used at work, and that the user's workplace is located in an area that carriers consider “outlying” within the market.

While this example demonstrates evaluation engine 112 working to eliminate product options, it is also possible to use rules and data to create alternatives that may not have been considered previously. This is a benefit unique to value-based product recommendation engines consistent with the present invention.

For example, a user may want a wireless phone calling plan with at least 600 minutes per month in talk time, but perhaps the user does not want to spend more than $50 per month and $200 dollars for the phone. Conventional attribute-based recommendation engines will not be able to reach a recommendation if no plan exists with attributes of (talk time>600) and (monthly cost<50). Product recommendation engines consistent with the present invention solve this problem by using a value-based framework. This user has indicated objectives of minimizing total cost and maximizing total use.

As evaluation engine 112 evaluates available plans, it does not filter out plans because they are expensive. Instead, all plans whose attributes support maximized use and minimized total cost are considered and the best set of phone/plan combinations are presented to the user. Logic engine 108 might infer that the total cost this user is willing to spend in a given year is $800. This data could be used to search for promotions where the total cost of yearly usage was less than or near to $800. For example, evaluation engine 112 might find a plan that costs $75 a month, has a free phone (e.g., via promotion and rebate), and has a base of 400 minutes but is giving users all incoming minutes free for a year. While the total cost of such a plan is $900 and none of the attributes match the initial attribute-based requirements of the user, the free incoming minutes more than make up for it, giving the user about 800 minutes a month for an extra $100. Due to the value-based framework, the user has a greater chance of being satisfied with the product recommended because his underlying needs and objectives are met.

If such a promotion did not exist, evaluation engine 112 can present a list of alternatives to the user and help the user determine which alternative is best. Evaluation engine 112 can enable side-by-side comparisons of the available options, allow the user to learn how product attributes are related to their needs and objectives, and help the user do a trade-off analysis based on his values. For example, some users seeking wireless phones and services would be willing to trade $25 dollars for 200 extra minutes of talk time. Others however, would only be willing to pay $10 extra for the same additional minutes.

FIG. 6 is a flow chart of the steps performed by evaluation engine 112 to enable the user to select between multiple product alternatives. First, evaluation engine 112 calculates the total count of the alternatives (step 602) and reviews the attribute values for each alternative (step 604). Next evaluation engine 112 generates a list of those attributes whose values are equal for all alternatives (step 606) and a list of the values of those attributes (step 608). Evaluation engine 112 then generates a list of all available attributes (step 610) and a list of all “distinguishing” attributes that are not on the list of equal attributes (step 612). Evaluation engine 112 presents two lists to the user: the list of all attributes showing the values of attributes whose values are equal for all alternatives (step 614) and the list of distinguishing attributes (step 616).

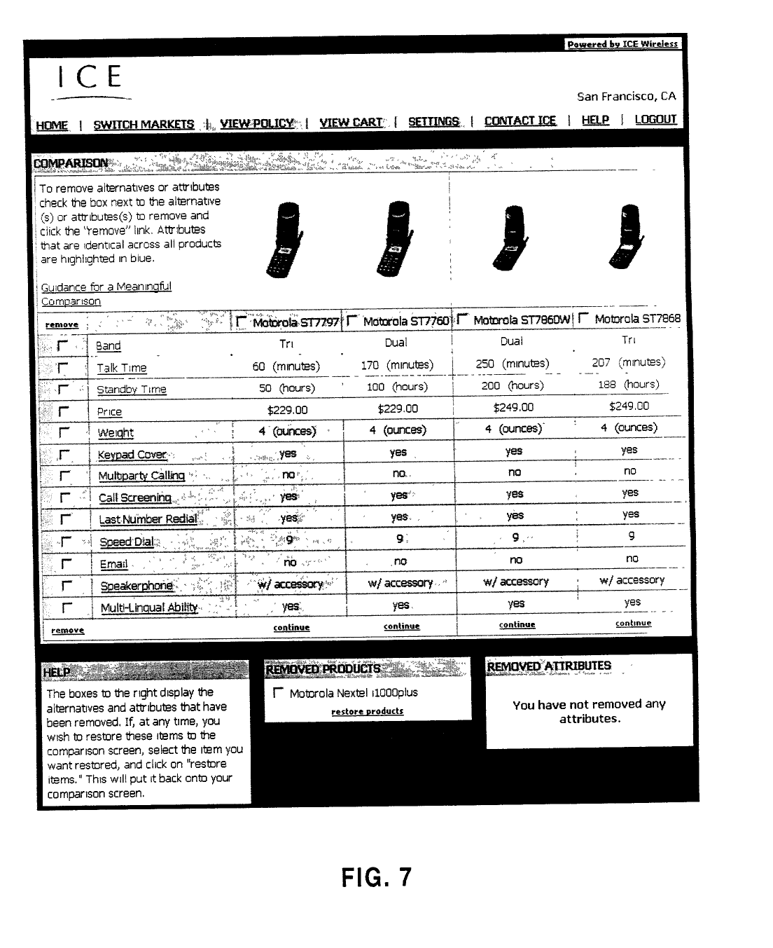

FIG. 7 is a sample screen shot of how evaluation engine 112 can present product alternatives to a user. As shown, attributes are listed in the left-hand column and the product alternatives are listed across the top of the table. Each alternative and each attribute has a check-box that enables the user to remove any attribute and/or alternative. As shown in FIG. 7, the attributes whose values are not equal for all alternatives (i.e., the distinguishing attributes) are highlighted to draw the user's attention to them. The attributes whose values are equal for all alternatives are not highlighted because they do not provide any assistance to the user in distinguishing between the alternatives.

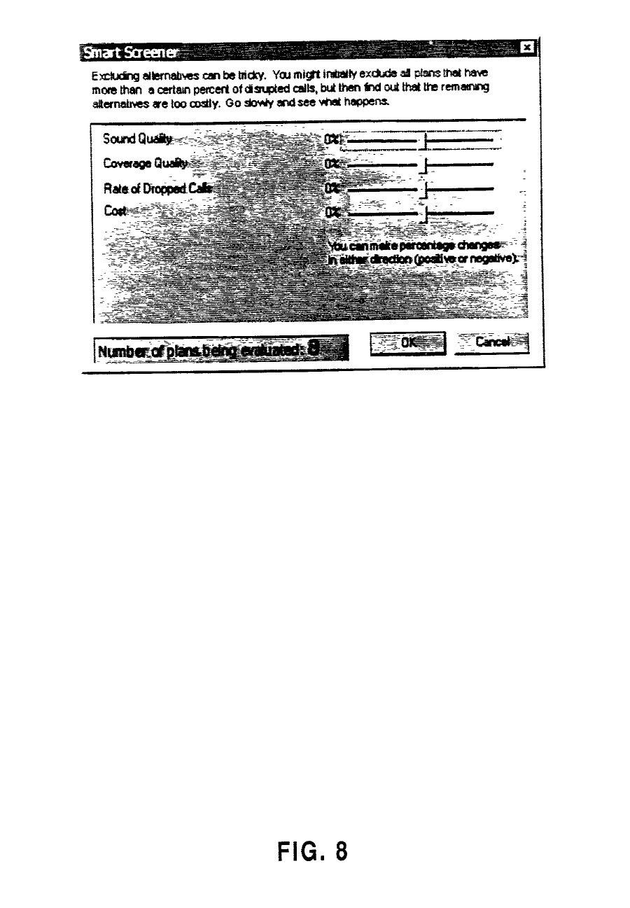

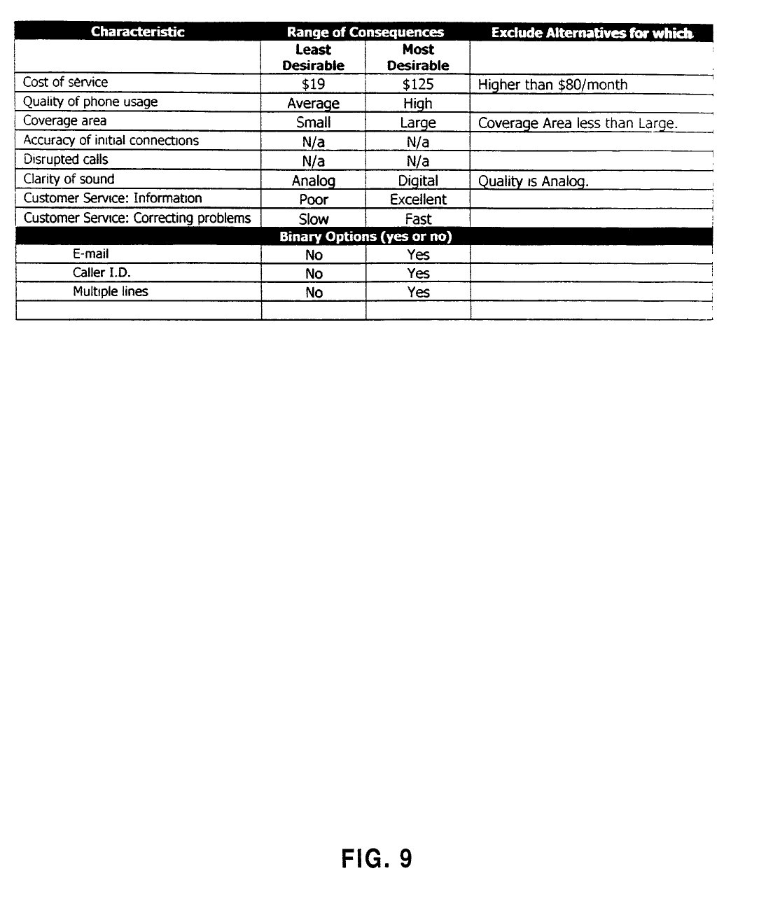

To further compare the alternatives, evaluation engine 112 can enable the user to rate and rank the alternatives or create filters to narrow the set of alternatives. FIG. 8 shows one embodiment, in which evaluation engine 112 uses a Java™ applet to enable a user to rank and rate each attribute value based on a percentage. FIG. 9 shows another embodiment, in which columns can be added to a comparison table, enabling the user to set exclusionary filters for the alternatives before ranking and rating. The “Range of Consequences” and “Exclude Alternatives for which” columns enable the user to interact with the data. In this embodiment, the other alternatives continue to be displayed to the right of the new columns while the user sets the filters.

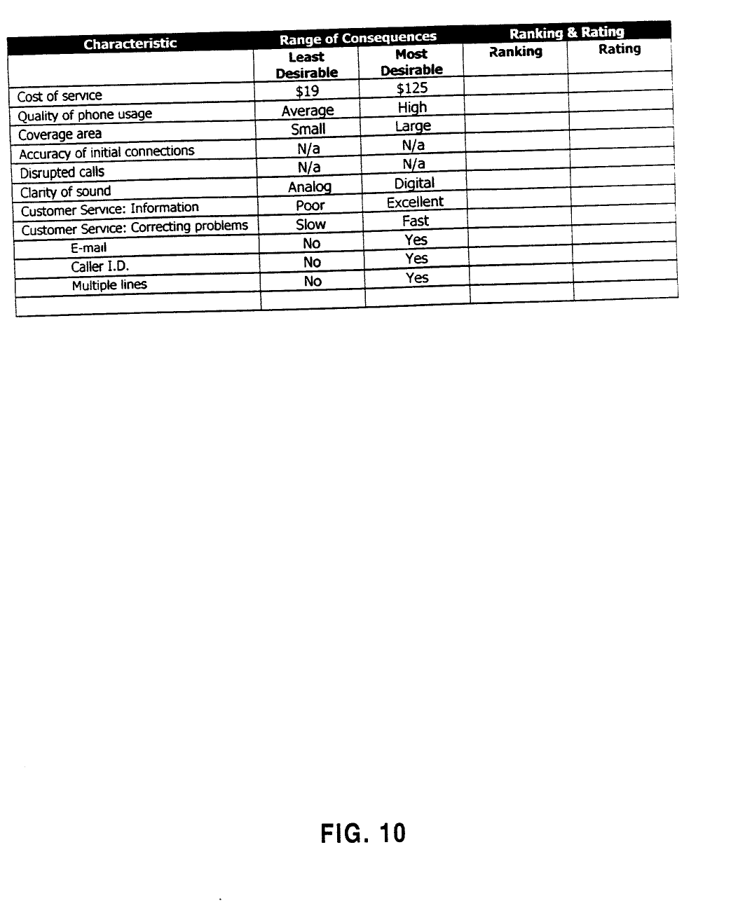

FIG. 10 shows a comparison table with columns added for ranking and rating product alternatives. The following instructions, which might be presented to the user with the comparison table, explain the ranking and rating functions.

A rating column has now been added to the comparison table. Please provide ratings of the relative importance of the plan attributes. To do this, a rating of 100 is assigned to the highest ranked attributes and you must type in relative rankings for the other attributes.

Suppose that for you, the change from the least desirable to the most desirable levels of the second ranked attribute is 60% as important as the change from the least desirable to most desirable levels of the highest ranked attribute. Then assign 60 as the rating of the second ranked attribute.

Now consider the third ranked attribute. Suppose that for you, the change from the lease desirable to the most desirable levels of the third ranked attribute is about two-thirds as important as the change from the lease desirable to the most desirable levels of the second ranked attribute. This would imply that 40 (i.e. two-thirds of 60) should be the rating assigned to the third ranked characteristic.

As a check, since 40 is 40% of 100, this implies that the importance of the change from the lease desirable to the most desirable levels of the third ranked attribute is 40% as important as the change from least desirable to the most desirable for the first ranked attribute. Stated differently, the change for the first ranked attribute is 2½ times as important as the change for the third ranked attribute. Continue in this manner to complete all of the ratings.

When evaluation engine 112 completes these user interactions, it triggers logic engine 108 to search through the product options and find the best recommendation for the user based not only on product attributes, but also on the relative worth of each of the attributes.

FIG. 11 is a flow chart of the steps performed by explanation engine 106. First, explanation engine 106 receives the product recommendation (step 1102) and the value-attribute pairs (step 1104) from evaluation engine 112. Explanation engine 106 uses the value-attribute pairs to justify the product recommendation, for example, by generating an explanatory paragraph (step 1106). Finally, explanation engine 106 displays the product recommendation and the justification to the user (step 1108).

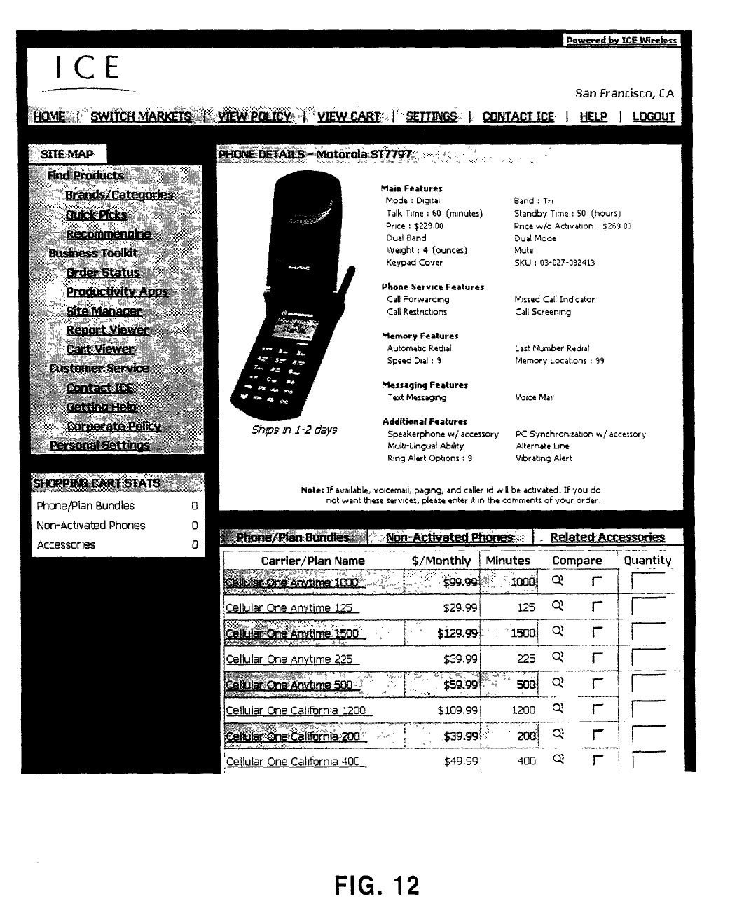

FIG. 12, is a sample screen shot showing how the product recommendation and justification might appear to the user. This screen is unique because it presents details about the recommended product and its related plans on a single page. This would be useful for a user purchasing multiple products, such as a company purchasing wireless phones for its employees. The company could select one wireless phone for all employees but select different calling plans for different types of employees. Using the screen in FIG. 12, this order could be placed on a single screen.

E. Alert Function

Another unique aspect of a product recommendation engine consistent with the present invention is its capacity to function as an “alert” engine. For example, the following message could be generated automatically once product recommendation engine 100 has stored the user's objectives and corresponding product attributes along with data about previous recommendations.

Dear User,

We know that you value keeping your monthly bill low and that is why we are contacting you today. Since you have a Nextel phone, you are eligible for one of the promotions they are currently running. Moreover, since you increased your minute plan twice in the past 12 months, we can offer you a discount The current promotion fits right in with the way you work. Since you travel most of the year, you will love this. Nextel has created a plan for California travelers (folks who rarely leave the state, of which you were one the last time we checked) where all incoming minutes are free and there are no roaming charges. There are only six days left to act, so let us know before the end of the month.

This alert feature can be triggered when new products are added to knowledge base 116, e.g., by re-evaluating all previous recommendations to determine which users would be better served by the new product. Commonly, certain accessories are available for only one type of product. By tracking the interest expressed by users, the alert feature can notify a user when a desired but previously unavailable accessory becomes available. The alert could also be directed by a management rule requiring a periodic review of products and past recommendations, e.g., at a company's request or per government rules.

The alert feature could also be used to influence the issuance of product accessories. Because trade-off decisions are captured by evaluation engine 112, valuable data is being captured about how much a particular product feature might be worth. For example, if users purchasing wireless phones state that they would be willing to spend $40 more per phone if they could read their e-mail on the road, this data could inform and guide product designers. In this case, the alert would be delivered to a different target audience, such as product designers and manufacturers.

F. Policy Advisor

Another unique aspect of a product recommendation engine consistent with the present invention is its ability to recommend a policy to a company. For example, a company might want to determine what wireless products should be used by the company's employees. As the following code listing demonstrates, a company's policy might have two parts:

Part One: Corporate Purchasing Approach (4 objects: Payment, Approval, Cost, Reports)

Payment.CreditCardAcceptance (yes, no)

Payment.POAcceptance (multiple, single, no)

Approval.SignatureRequired (all, dollar_amt, no)

Cost.InitialCost (<amt)

Cost.MonthlyCost (<amt)

Reports.Recommendations (yes, no)

Reports.Purchases (yes, no)

Reports.Accessories (yes, no)

Part Two—Corporate Templates (3 objects: Market, Company, UserType)

[Goal]

UserType.Market

UserType.Carrier.

UserType.Phone.

UserType.TypeName.

Market.ActivationMarkets (string list with market code)

Market.CorporateOffices (string list with market code)

Company.Internal Communication (normal, high)

Company.Coverage Need (typical, outlyingareas, all)

Company.Long_Distance_Type (state, national, international)

Company.Long_Distance_Need (no, normal, high)

Company.Roaming_Type (no, local, state, national, international)

Company.Roaming_Need (no, low, normal, high)

As this listing shows, the rule sets are similar to those used in helping individual users. Information is captured via a survey to create objectives, and rules are used to create templates that can be used for the different users in the company.

These templates are stored in discovered data store 114 and can include filters that are used when an employee of the company seeks to purchase a product. Some examples of templates follow.

NetForce, New York Office, IT Staff

NetForce, New York Office, Sales Staff

NetForce, New York Office, Executive Staff

NetForce, LA Office, IT Staff

NetForce, Western Region, Customer Support Staff

These templates define three things: 1. the company that owns the template; 2. the activation market (i.e., giving the phone a local phone number); and 3. the usertype.

Corresponding rules can be stored in the rules base, such as:

Activ_Market (2, Company) if company=x then activ_markets=2

Office (NY, Company) if company=x then location=NY

Office (SF, Company) if company=x then location=SF

Usertype (tech, Company) if company=x then usertype=tech

Usertype (sales, Company) if company=x then usertype=sales

TotalCost (Lowest, Company) if company=x then totalcost=lowest

CarrierName (Nextel,Company) if company=x then Carrier=Nextel

The template provides a starting point, with much of the data necessary for a product recommendation already populated in knowledge base 114.

Although the preferred embodiments of the present invention have been described in detail herein, it is to be understood that these descriptions are merely illustrative. The present invention may be used to recommend any wireless products (i.e., goods (such as phones) and/or services and/or features and/or policies), including messaging services, hosted application services, switching, sales force automation, knowledge systems, etc.

1. A method for recommending a wireless product to a user, comprising the steps of:
interacting with the user to obtain the user's objectives for the wireless product;
using a set of rules to map the user's objectives to a corresponding set of product attributes;
selecting one or more wireless product alternatives having at least one of the product attributes;
enabling the user to evaluate the one or more wireless product alternatives by comparing the product attributes of the one or more wireless product alternatives; and
presenting a recommended wireless product to the user.

2. The method of claim 1, further including the step of:
presenting an explanation of the recommended wireless product based on the user's objectives and the corresponding set of product attributes.

3. The method of claim 1, wherein the using step further includes the substep of:
applying a sequence of rules wherein the outcome of the first rule determines the next rule applied.

4. The method of claim 1, wherein the wireless product recommendation is a wireless policy for a company.

5. The method of claim 1, further comprising the steps of:
storing the user's objectives with the corresponding set of product attributes;
receiving a set of new product attributes describing a new wireless product;
matching the set of new product attributes to the user's objectives using the corresponding set of product attributes; and
sending a message to the user recommending the new product, if the new product attributes match the user's objectives.

6. The method of claim 1, wherein the wireless product recommendation is a wireless service.

7. The method of claim 1, wherein the wireless product recommendation is a wireless phone.

8. The method of claim 1, wherein the wireless product recommendation is a wireless feature.

9. A method for recommending a wireless product to a user, comprising the steps of:
creating a survey to obtain information relating to the user's objectives for the wireless product;
delivering the survey to the user;
capturing a response to the survey from the user;
storing the response to the survey;
processing the response using a rule set to determine product attributes corresponding to the user's objectives;
selecting one or more wireless products based on the product attributes corresponding to the user's objectives;
interacting with the user to evaluate the one or more wireless products by comparing the product attributes of each of the one or more wireless products;
determining a wireless product recommendation from among the one or more wireless products; and
explaining the wireless product recommendation based on the product attributes and the user's objectives.

10. The method of claim 9, wherein the processing step further includes:
making an inference based on the rule set and the response; and
storing the inference with the survey response from the user.

11. The method of claim 9, wherein the processing step further includes the substep of:
applying a sequence of rules wherein the outcome of the first rule determines the next rule applied.

12. The method of claim 9, further comprising the step of:
verifying the wireless product recommendation using the rule set.

13. The method of claim 9, wherein the wireless product recommendation is a wireless service.

14. The method of claim 9, wherein the wireless product recommendation is a wireless phone.

15. The method of claim 9, wherein the wireless product recommendation is a wireless feature.

16. A system for recommending a wireless product to a user, comprising:
a survey engine configured to obtain information from a user relating to the user's objectives for the wireless product;
a logic engine having a rule set and configured to apply one or more rules in the rule set;
an evaluation engine configured to process the user's response to determine product attributes corresponding to the user's objectives,
select one or more wireless products based on the product attributes corresponding to the user's objectives,
interact with the user to evaluate the one or more wireless products by comparing the product attributes of each of the one or more wireless products, and
determine a wireless product recommendation from among the one or more wireless products; and
an explanation engine configured to explain the product recommendation based on the product attributes and the user's objectives.

17. The system of claim 16, further comprising:
a discovered data store configured to store the user's response and the product attributes corresponding to the user's objectives.

18. The system of claim 16, further comprising:
a knowledge base configured to store a listing of products and corresponding attributes.

19. A user interface for evaluating one or more wireless products, the user interface presented to a user at a client computer running a browser, the user interface comprising:
a first component including a list of attributes of the one or more wireless products;
a second component including a description of each of the one or more wireless products, wherein the description corresponding to each wireless product includes a value for each attribute;
a first set of check-boxes enabling the user to request the removal of any of the listed attributes from the display;
a second set of check-boxes enabling the user to request the removal of any of the wireless products from the display; and
a remove button enabling the user to execute a removal request.

20. The user interface of claim 19, further comprising:
a replace button enabling the user to replace attributes or wireless products that have been removed using the remove button.

21. The user interface of claim 19, further comprising:
a text highlight indicator applied to the value for an attribute of each wireless product when the value of the attribute is equal for all of the wireless product.

22. The user interface of claim 19, further comprising:
a text highlight indicator applied to the value for an attribute of each wireless product when the value of the attribute is not equal for all of the wireless product.

23. A user interface for presenting a recommended wireless good and related wireless services, the user interface presented to a user at a client computer running a browser, the user interface comprising:
a first component including a description of the recommended wireless good;
a second component including a list of attributes of the recommended wireless good;
a third component including a list of one or more wireless service alternatives related to the wireless good; and
for each of the one or more wireless service alternatives, a quantity box for receiving input from the user indicating the number of each wireless service alternative the user wishes to purchase.

24. The user interface of claim 23, further comprising:
a fourth component including an image of the recommended wireless good.

25. The user interface of claim 23, further comprising:
a link corresponding to each of the one or more wireless service alternatives that opens a window containing a description of the wireless service alternative without replacing the user interface.

26. A method for recommending a wireless product to a user, comprising the steps of:
interacting with the user to obtain the user's objectives for the wireless product;
using a set of rules to map the user's objectives to a corresponding set of product attributes;
selecting one or more wireless product alternatives having at least one of the product attributes;
enabling the user to evaluate the one or more wireless product alternatives by comparing the product attributes of the one or more wireless product alternatives;
presenting a recommended wireless product to the user;
storing the user's objectives with the corresponding set of product attributes;
receiving a set of new product attributes describing a new wireless product;
matching the set of new product attributes to the user's objectives using the corresponding set of product attributes; and
sending a message to the user recommending the new product, if the new product attributes match the user's objectives.

27. A system for recommending a wireless product to a user, comprising:
a survey engine configured to obtain information from a user relating to the user's objectives for the wireless product;
a logic engine having a rule set and configured to apply one or more rules in the rule set; and
an evaluation engine configured to process the user's response to determine product attributes corresponding to the user's objectives,
select one or more wireless products based on the product attributes corresponding to the user's objectives,
interact with the user to evaluate the one or more wireless products by comparing the product attributes of each of the one or more wireless products, and
determine a wireless product recommendation from among the one or more wireless products.

28. A method for comparing a plurality of wireless product alternatives, comprising the steps of:
displaying a list of attributes corresponding to the wireless product alternatives;
for each attribute,
displaying a value corresponding to the least desirable wireless product alternative,
displaying a value corresponding to the most desirable wireless product alternative, and
requesting a user to assign a rating to the attribute indicating a relative importance of the attribute; and
determining a wireless product recommendation from the wireless product alternatives based one or more attributes assigned a high relative importance by the user.
